(19) United States
(12) Patent Application Publication
(10) Pub. No.: US 2012/0260918 A1
(43) Pub. Date: Oct. 18, 2012

(54) METHOD OF CONTROLLING A POWERED AIR PURIFYING RESPIRATOR

(76) Inventors: Terence M. Sayers, County Durham (GB); Bengt Kallman, Leksand (SE); Andrew Murphy, Durham (GB); Desmond T. Curran, Durham (GB)

(21) Appl. No.: 13/502,884

(22) PCT Filed: Oct. 29, 2010
(86) PCT No.: PCT/US10/54622

§ 371 Date: Jun. 14, 2012

(30) Foreign Application Priority Data
Nov. 2, 2009 (GB) 019101.6

(51) Int. Cl. A62B 7/10

(52) U.S. Cl. 128/204.21

(57) ABSTRACT

A method of controlling a powered air purifying respirator blower system to detect a low air pressure high airflow event is disclosed. The blower system comprises a fan powered by an electric motor, controlled by an electronic control unit for delivering a forced flow of filtered air to a user. The electronic control unit has a plurality of data points representing events defining an acceptable operating range in terms of different characteristics of the blower system stored therein. The method comprises sampling a characteristic that represents the operating condition of the blower to obtain a sampled data point; comparing the sampled data point and the stored data point representing a low air-pressure high airflow event, for the same characteristic; repeating the sampling during a fixed time period, and if the comparing step indicates the low air-pressure high airflow event has been reached for the majority of the time period; activating an alarm. Use of a respirator employing the method to deliver a forced flow of filtered air to a contained user environment is also disclosed.

The present invention relates to a method of controlling a blower system, for use in a powered air purifying respirator (PAPR), in particular, to detect a low air-pressure high airflow event.

### BACKGROUND

When working in areas where there is known to be, or there is a risk of there being, dusts, fumes or gases that are potentially hazardous or harmful to health, it is usual for the worker to use a respirator. A common type of respirator used in such circumstances is a powered air purifying respirator (PAPR). A PAPR has a blower system comprising a fan powered by an electric motor for delivering a forced flow of air to the respirator user. A turbo unit usually includes a housing that typically contains the blower system, and is adapted to connect a filter to the blower system.

Air is drawn through the filter by the blower system and passed from the turbo unit through a breathing tube to one of a mask, or a contained user environment, such as mask, helmet, hood or suit (where the user is contained within an environment separated from ambient and external conditions) thus providing filtered air to the user's breathing zone (the area around their nose and mouth). A blower system for a PAPR may also include an electronic control unit to regulate the power driving the fan. Typically, a single power supply, for example a battery, provides power for both the fan and the electronic control unit.

Sufficient airflow is required by the user to ensure that the designated level of respiratory protection is maintained. For example, too low an airflow can cause ingress of contaminants into the user's breathing zone. In response to this, the electronic control unit may be used to trigger alarms to the user, for example, to alert the user if the airflow falls below a designated level, or to alert the user that the filters may be blocked with dust and need to be replaced. It is also common for the electronic control unit to trigger an alarm if the battery is depleted to a level where the correct operation of the PAPR is likely to be compromised.

It is desirable that the user of a PAPR can be alerted if an event occurs that takes the operation of the PAPR outside of the defined operation range. This is particularly desirable now that PAPR suit systems are available. If the integrity of a suit is compromised it can often go unnoticed by the user.

### SUMMARY

The present invention provides a method of controlling a powered air purifying respirator blower system to detect a low air-pressure high airflow event, the system comprising a fan powered by an electric motor, controlled by an electronic control unit for delivering a forced flow of filtered air to a user, and the electronic control unit having a plurality of data points representing events defining an acceptable operating range in terms of different characteristics of the blower system stored therein, the method comprising: sampling a characteristic that represents the operating condition of the blower to obtain a sampled data point; comparing the sampled data point and the stored data point representing a low air-pressure high airflow event, for the same characteristic; repeating the sampling during a fixed time period, and if the comparing step indicates the low air-pressure high airflow event has been reached for the majority of the time period; activating an alarm.

By taking into consideration deviations of the operating condition from the blower system operating range, for example an increase in airflow and/or a decrease in blower system air pressure, the user can be alerted to the situation where the PAPR system has been compromised to allow them to take appropriate action.

Other features of the invention will be apparent from the attached dependent claims.

The present invention provides a method of controlling a powered air purifying respirator blower system where the sampling is carried out by the electronic control unit.

Preferably, the characteristic sampled is one of: voltage across the motor; current through the motor; speed of the motor; or any combination thereof. In this situation the low air-pressure high airflow event is a minimum acceptable value for the characteristic sampled.

The present invention further provides a method of controlling a powered air purifying respirator blower system where the sampling is carried out using a sensor external to the electronic control unit.

The present invention yet further provides a method of controlling a powered air purifying respirator blower system where the characteristic sampled is one of air-pressure or airflow. In the situation where the characteristic is air-pressure, the low air-pressure high airflow event is a minimum acceptable value. Alternatively, in the situation where the characteristic is airflow, the low air-pressure high airflow event is a maximum acceptable value.

The alarm is at least one or more of an audible alarm, a visible alarm, or a vibration alarm.

Preferably, the fixed time period is in the range of 3 to 30 seconds. Preferably, the respirator delivers a substantially uniform volumetric airflow to a user.

Preferably, the respirator operates at one of: a substantially constant current and a substantially constant voltage.

The present invention also provides for the use of a respirator employing a method of controlling a powered air purifying respirator blower system, to deliver a forced flow of filtered air as described above to contained user environment. Preferably, the contained user environment is one of a mask, a helmet or a hood. Alternatively the contained user environment is a suit.

### BRIEF DESCRIPTION OF THE DRAWINGS

By way of example only, an embodiment of the invention will now described below with reference to the accompanying drawings, in which:

FIG. 1a is a diagrammatical graph of a constant current operating range;

FIG. 1b is a diagrammatical graph of a uniform volumetric airflow operating range;

FIG. 2 is a diagrammatical illustration of a powered air purifying respirator;

FIG. 3 shows a block diagram of a blower system for the air purifying respirator of FIG. 3; and

FIG. 4 shows a flow diagram of a blower control sequence according an embodiment of the present invention.

### DETAILED DESCRIPTION

Many electronic control units deliver either a constant current or a constant voltage to the electric motor so that the airflow from the blower system is not affected as the battery is depleted during operation of the PAPR. Some electronic control units control the power to the electric motor with the aim of maintaining a substantially uniform volumetric airflow from the blower system.

Such electronic control units often compensate for both changes in battery voltage and also compensate for changes in the filter pressure drop as the filter clogs with dust or particles. The term “volumetric airflow” indicates the volume of air provided to a user at any one time as opposed to the mass of air provided to a user any one time.

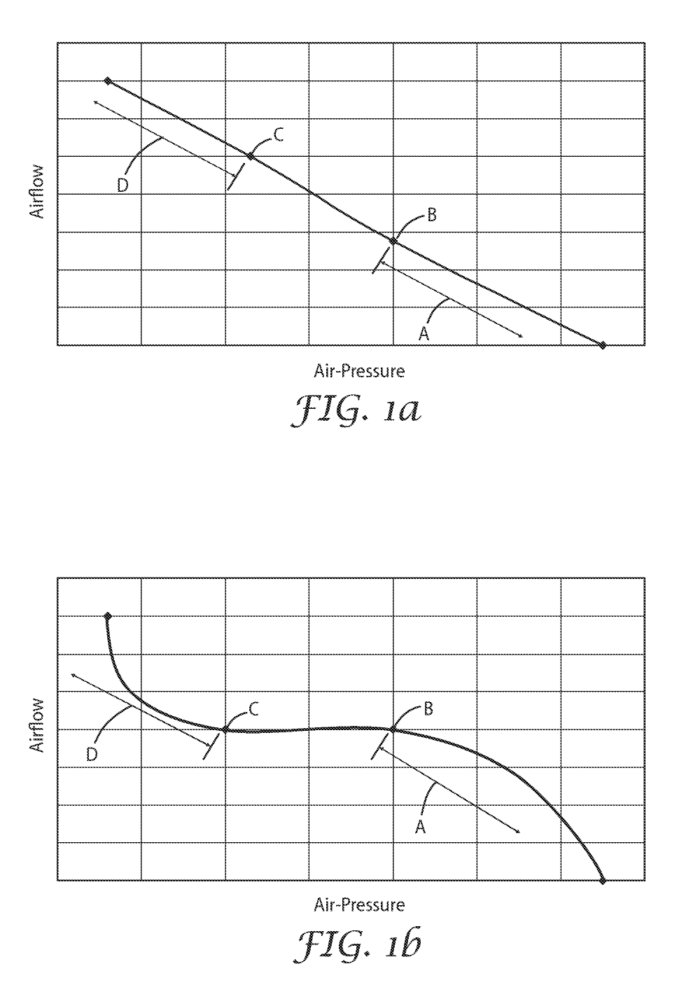

The three types of control systems: constant current; constant voltage; and volumetric airflow, operate using parameters set within defined operating ranges for each of the electrical characteristics of the motor (voltage across the motor, current through the motor and motor power, speed of the motor), as well as for the air-pressure and airflow produced by the motor. FIG. 1a is a diagrammatical graph of a constant current operating range and FIG. 1b is a diagrammatical graph of a uniform volumetric airflow operating range. The exemplary constant current controlled blower system operating range is similar to that of a constant voltage operating range. The graph of FIG. 1a shows that the airflow from the blower system increases as the air-pressure drop across the blower system decreases. The section of the graph marked A represents insufficient airflow to maintain the desired level of respiratory protection. This is the high air-pressure low airflow operating range. The section of the graph between points B and C is the desired operating range where sufficient airflow is delivered to the user to maintain suitable respirator protection. The airflow from a constant current or constant voltage blower system is likely to reduce over time as the pressure drop of the filter connected to the blower increases due to clogging with dust or particles. However, the operating range during the lifetime of the blower will be broadly consistent with the operating range shown. B represents the high air-pressure low airflow event where a low airflow alarm would be triggered. C represents the low air-pressure high airflow event, above which, it is likely that the integrity of the PAPR has been compromised, marked as region D on the graph. The characteristic curve of FIG. 1b has a flat section between points B and C where the desired operating airflow is uniform and sufficient to maintain suitable respirator protection. The section of the graph marked A representing insufficient airflow to maintain the desired level of respiratory protection is the high air-pressure low airflow operating range. Similar to FIG. 1a, point C of FIG. 1b represents the low air-pressure high airflow event, above which, in the region marked D, it is likely that the integrity of the PAPR has been compromised.

If an event occurs that causes the airflow to be reduced or the air-pressure across the blower system to increase (a high air-pressure low airflow event), it is likely that a low airflow alarm will be triggered to alert the user to the fact that they are not receiving sufficient filtered air and that ingress of potentially contaminated air into their breathing zone is likely. However, there is no provision for the triggering of an alarm when an event occurs that causes the air-pressure to drop or the airflow to rise (a low air-pressure high airflow event).

The following are some examples of problems that can arise that are unlikely to trigger an alarm in current PAPR systems. Each of these represents a low air-pressure high airflow event. A failure in the filtering process of a PAPR, such as the filter media being inadvertently damaged or punctured can result in potentially contaminated air to ingress the user's breathing zone. Furthermore, breaches of system integrity such as a filter not being fitted properly, a filter being fitted without a gasket or seal, or a filter becoming removed or partially removed during use may give rise to similar events. If the breathing tube is incorrectly fitted to the mask, helmet, hood or suit, or to the turbo outlet, or becomes disconnected or damaged during use similar events are likely to occur. Likewise, if a local contained user environment, such as a mask, helmet, hood or suit to which the PAPR is attached is torn or damaged or otherwise compromised, a situation where potentially contaminated air may ingress the users breathing zone may occur. In addition, if any mask, helmet, hood or suit is removed during use and the PAPR turbo is left running, current commercially available PAPRs do not trigger an alarm.

The present invention is based on the realization that currently known methods of controlling a blower system currently employed in PAPRs do not trigger an alarm when the PAPRs integrity is compromised as described above. Furthermore, it has been realised that the above described problems result in the blower system developing a high airflow low air-pressure event and as such the blower system parameters can be used to provide the electronic control unit with information about the environment that the blower system is operating within and more particularly information about a contained user environment, such as a mask (for example, a full face respirator mask, a half face respirator mask, and so on.), helmet, hood or suit that the blower system is supplying. Such an event may also sometimes be referred to as indicating a breach in the integrity of the contained user environment.

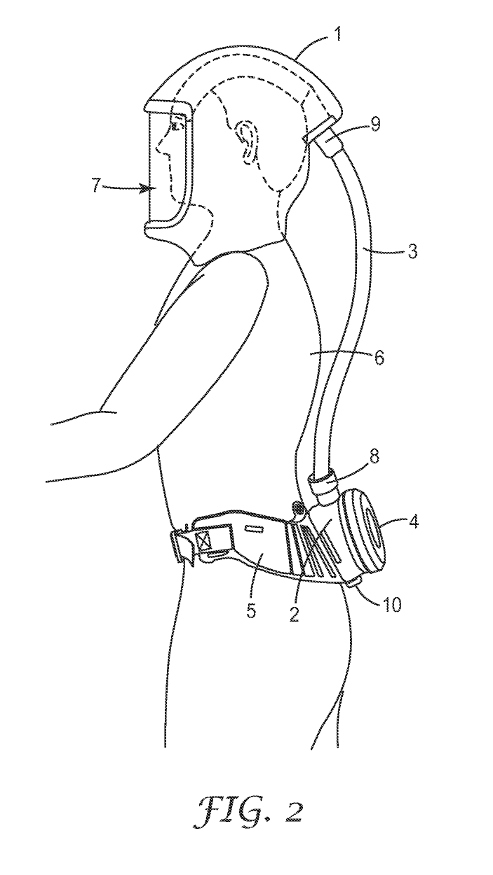

One exemplary embodiment of the present invention described below employs a turbo as shown in FIG. 2. FIG. 2 is a diagrammatical illustration of a powered air purifying respirator. The air purifying respirator shown is a volumetric airflow device, but the components would be similar, and sometimes, substantially identical for both the constant voltage and constant current devices mentioned above. The exemplary PAPR comprises a head or a face piece, such as a hood 1, a turbo unit 2, a breathing tube 3, a filter 4 and turbo support, such as a belt 5. The hood 1 is worn on the user's 6 head. It at least partially encloses the user's 6 head to form a breathing zone 7, that is, the area around their nose and mouth, so that the filtered air is directed to this breathing zone 7. The turbo unit 2 may be attached to a belt 5 to enable it to be secured about the user's torso. The turbo unit 2 usually includes a housing (not shown) that houses a blower system (not shown), which draws the air through the PAPR system using a fan (also not shown). The turbo unit 2 supplies air to the hood 1 through the breathing tube 3 which is connected between the outlet 8 of the turbo unit 2 and the inlet 9 of the hood 1. The turbo unit 2 is fitted with a filter 4, which can be either inside the turbo unit or attached to the turbo unit as shown in FIG. 2 such that the filter 4 is in the airflow path, preferably disposed upstream of a fan opening of the blower. The purpose of providing the filter 4 is to remove at least a certain amount of particles and/or gases and/or vapours from the ambient air before the air is delivered to the user 6. The battery pack 10, which is fitted to the turbo unit 2 provides power to the electronic control unit 18 and to the motor 17 (both shown in FIG. 2 as discussed below).

Although a hood is illustrated in FIG. 2, the hood 1 could substituted by another head piece or face piece, such as a mask, a helmet or a full suit, provided that a closed user environment, covering at least the original area of the user's face, to direct air to the user's breathing zone 7, is created.

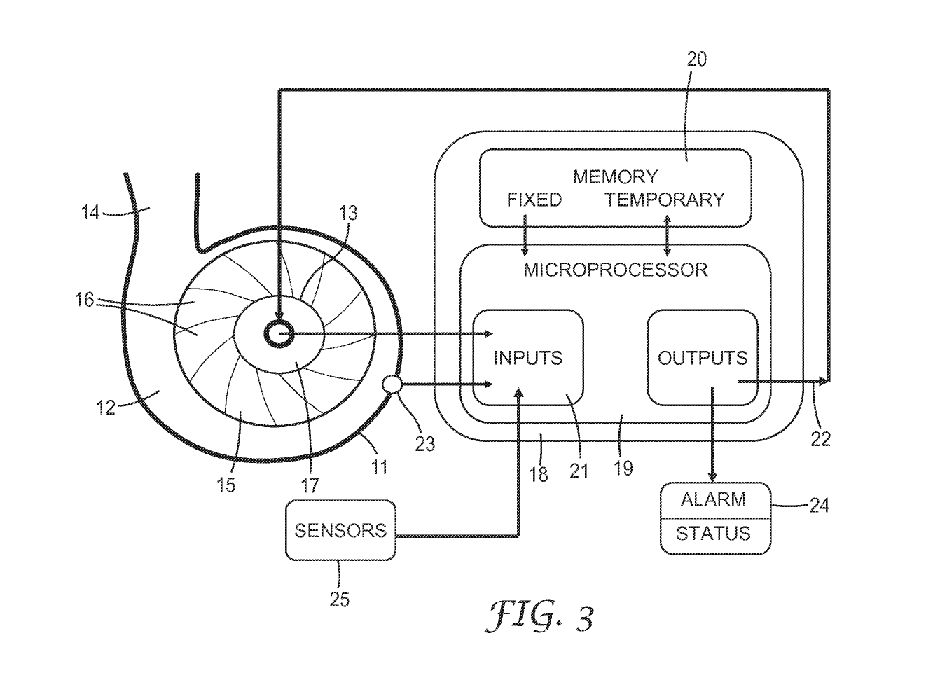

The following illustrates how the blower system for an air purifying respirator may function. In the following examples, the structural components of the PAPR may be assumed to be as described above with reference to FIGS. 2 and 3.

FIG. 3 shows a block diagram of a blower system for the air-purifying respirator of FIG. 2. This blower system is housed within the turbo unit 2 illustrated in FIG. 2. In accordance with this embodiment of the invention the blower 11 includes a housing 12 having an inlet 13 and an outlet 14. The blower 11 further includes a fan 15, having a plurality of blades 16, driven by a motor 17. The blower 11 is controlled by an electronic control unit 18 which regulates the power provided to the motor 17.

With further reference to FIG. 3, the blower system comprises an electronic control unit 18 that functions to maintain a substantially uniform, preferably constant, volumetric airflow to the hood 1. The electronic control unit 18 comprises: a microprocessor device 19, such as a single chip microcontroller, for computing information; a memory device 20, such as flash RAM, for storing information, for example, calibration data and sensor input receivers 21a, 21b, 21c, for receiving data from sensors such as sensors to detect the voltage across the motor, sensors to detect current through the motor and sensors to detect the speed of the motor. Also included is an output controller 22, such as a pulse width modulation controller chip, for providing power to the motor 17 and any alarm or status indicators, such as buzzers or light emitting diodes that may be included in the PAPR. The memory device 20 of the electronic control unit 18 has two parts: a fixed memory and a temporary memory. The fixed memory is populated with data, for example, at the time of manufacture, comprising the algorithms and programs for enabling the microprocessor 19 to carry out its calculations and procedures, and calibration information from the factory calibration procedure. The temporary memory is used for storing data and information such as sensor readings and fan and motor operating parameter data collected during start-up and running of the turbo unit 2. If desired, this data maybe erased when the turbo unit 2 is powered down.

In this embodiment of the present invention speed of the motor and motor voltage are the characteristics chosen to determine the operating condition of the blower system. The speed of the motor may be measured by means of a sensor 23 that is connected to the blower 11 and measures the number of revolutions of the fan 15 in a given time period. A suitable type of sensor for measuring the speed of the motor would be a Hall Effect device, although other types of sensor, for example optical sensors, could be used. The speed of the motor information is received by the microprocessor device 19 of the electronic control unit 18. The applied voltage 22 to the electric motor 17 may be monitored directly by an input 21 to the microprocessor 19 of the electronic control unit 18. This means that, in this exemplary embodiment, two of the sensor inputs 21b, 21c provided are inactive during this particular method of use, but may be activated if alternative characteristics are chosen.

During the factory setup and calibration of the exemplary blower system, of FIG. 3, a plurality of data points, including those relating to the operating characteristics described above, (speed of the motor and voltage across the motor), representing events defining an acceptable operating range of the blower 11 may be stored in the fixed memory 20 of the electronic control unit 18. The stored data points may include data points that represent a low air-pressure high airflow (LPHF) event at the limit of the acceptable operating range (see FIG. 1b).

When the blower 11 is started up and during use, the electronic control unit 18 endeavours to maintain a substantially uniform volumetric airflow. The required volumetric airflow may be predetermined during the factory setup. For example the volumetric airflow is preferably in the range of, but not limited to 70 to 250 litres/minute and is dependent on the level of respiratory protection required by the PAPR and the type of mask, helmet, hood or suit used by the PAPR.

More preferably the volumetric airflow is in the range 120 to 220 litres/minute, yet more preferably in the range 160 to 200 litres/minute. During use of the blower 11 the electronic control unit 18 samples data points for the blower system operating characteristics and compares them with the stored data points. If certain predetermined criteria are met the electronic control unit 18 will trigger an alarm 24 to be activated to warn the user that an unacceptable event has occurred.

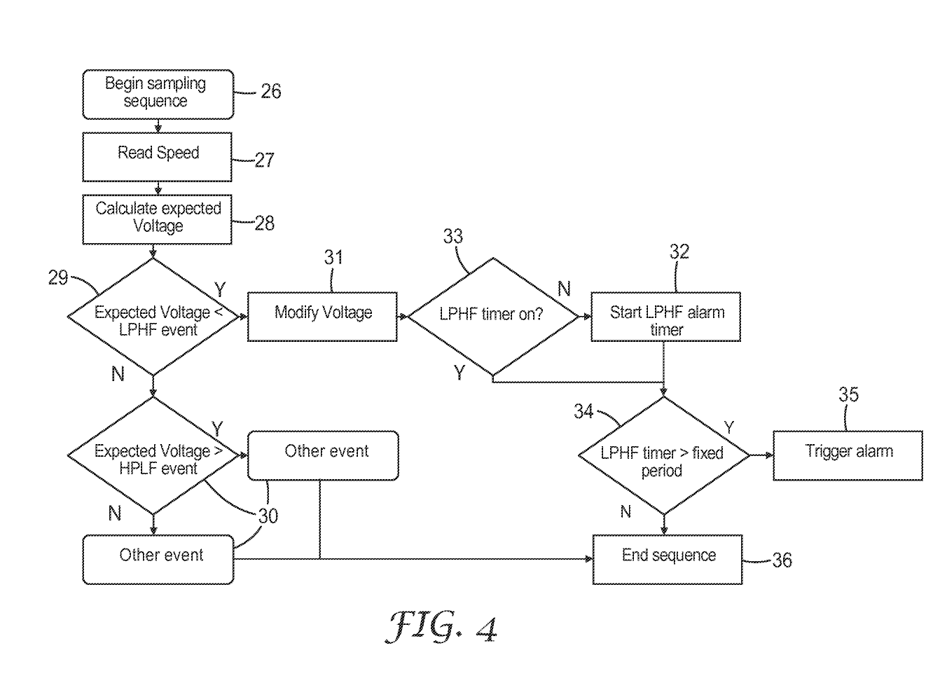

FIG. 4 shows a flow diagram of a blower system control sequence according to an embodiment of the present invention. In this exemplary embodiment, when the turbo unit 2 is started up, an algorithm stored in the fixed memory 20 of the electronic control unit 18 begins the sampling sequence at step 26.

The sequence of FIG. 4 is repeated, usually a plurality of times, by the electronic control unit 18 at regular intervals predetermined by the algorithm stored in the fixed memory 20. For example the interval between consecutive samples is in the range of, but not limited to 2 to 50 ms, more preferably in the range 2 to 20 ms, yet more preferably in the range 2 to 10 ms. A rolling average algorithm is often used in such systems, wherein a plurality of samples are collected and average to reduce the effect of electrical noise in the system. In this embodiment of the present invention a rolling average of 60 samples is used. Each sampled data point is processed as follows.

At step 27 the speed of the motor is measured by the electronic control unit 18 by means of the sensor 23 in the blower 11 and stored in the temporary memory 20. From the stored speed of the motor data point the electronic control unit 18 calculates the expected motor voltage, at step 28, for that particular speed of the motor 17 by referring to the stored data points stored in the fixed memory 20 from the calibration of the blower system, and stores the result in the temporary memory 20. At step 29 the electronic control unit 18 compares the data point in the temporary memory 20 for the expected motor voltage and the motor voltage data points stored in the fixed memory that represent a low air-pressure high airflow (LPHF) event. If the expected motor voltage is higher than the event motor voltage, the electronic control unit proceeds to follow a sequence of steps 30 to check and maintain a substantially uniform airflow and to check for other blower system events. If, however, the expected motor voltage is lower than the event motor voltage, the electronic control unit adjusts the actual motor voltage at step 31 (for example, by means of a pulse width modulation controller) to be equal to the high airflow event motor voltage and starts a high airflow timer, step 32. The sequence is repeated at regular intervals, as described above. After subsequent data points are sampled, the high airflow timer may either be cancelled or remain active, as appropriate at step 33. If the timer remains active for a fixed time period at step 34, indicating that the low air-pressure high airflow (LPHF) condition has been present for the majority of that period, the electronic control unit 18 will trigger to activate an alarm 24 at step 35 to the user. The fixed time period is in the range of, but not limited to 3 to 30 seconds, more preferably in the range 5 to 15 seconds, yet more preferably in the range 8 to 12 seconds. If further data points outside of this time range are sampled and the low air-pressure high airflow (LPHF) event is no longer detected, the alarm is cancelled. Alternatively the alarm may be manually cancelled by the user, for example by turning the PAPR off.

The low air-pressure high airflow alarm 24 according to an embodiment of the present invention may comprise a visual alarm, an audible alarm, a vibration alarm or any combination thereof. The visual alarm is preferably given by means of a light, such as a light emitting diode (LED) or a bulb, that is visible external to the turbo unit. However, the visual alarm may be an alternative type indicator, for example: a warning message; a numeric display or a liquid crystal display (LCD), or another suitable device. The visual alarm may be continuous, intermittent, or display information or coded information to the user. For example, if the visual alarm comprises a light, the light may be flashed intermittently to attract the attention of the user. The audible alarm is preferably given by a piezoelectric device, although alternative types of sounders or buzzers may be used, for example, electro-mechanical buzzers. The audible alarm may be continuous or intermittent, or may be variable in volume and/or in the frequency of the sound produced. For certain applications, such as noisy environments where it may be difficult for the user to hear an audible alarm, it may be desirable to use a vibration alarm such as those commonly found in mobile phones. The vibration alarm may be set to vibrate continuously or intermittently. Each type of alarm may be used alone or in combination with one or more other types of alarm. For example, it may be desirable to operate an intermittent visual alarm and an intermittent audible alarm simultaneously, ensuring that the flashing of the visual alarm occurs contemporaneously with the sounding of the audible alarm. Another exemplary combination may be the use of an audible and a vibration alarm simultaneously.

In the above embodiment, the motor characteristics of speed of the motor and voltage across the motor are used to determine a low air-pressure high airflow event, and measured directly using sensors external to the motor. Alternatively, other characteristics of the blower system representing the operating condition may be used. These may be any electrical characteristics of the blower 11, giving an indirect measurement of air-pressure and airflow, measured by the electronic control unit 18 or an additional sensor 25, for example, current through the motor or motor power. However, the physical characteristics of air-pressure or airflow may be measured directly, using sensors 25, which may be disposed external to the motor 17. For example, the air-pressure could be measured by a pressure sensor adapted to compare the pressure between the inlet 13 and the outlet 14 of the blower 11, or airflow could be measured by an airflow sensor positioned in the airflow path at the outlet 14 of the blower 11. Preferably therefore the characteristic sampled is one of: voltage across the motor; current through the motor; speed of the motor; or any combination thereof. Alternatively the characteristics sampled may be one of air-pressure or airflow.

If the characteristic sampled is one of voltage across the motor 17; current through the motor; motor power or speed of the motor, it is likely that the low air-pressure high airflow event is represented by a minimum acceptable value. If the characteristic sampled is air-pressure, then the low air-pressure high airflow event is also represented by a minimum acceptable value. However, if the motor characteristic sampled is airflow, then the low air-pressure high airflow event is represented by a maximum acceptable value.

Where a PAPR blower control system uses constant voltage or constant current control, the method of providing an alarm if the operating condition reaches a low air-pressure high airflow event is similar to the above. The difference is that often the motor voltage or motor current is fixed by the electronic control unit after the initial start-up and substantially maintained during use. Hence step 31 of adjusting the motor voltage is often not employed in such systems, but the remaining method steps described above are carried out to determine if an alarm should be activated. Although in the above embodiment a uniform volumetric airflow system is described, a uniform mass airflow system may be used, where a substantially constant mass of air is delivered to the user rather than a substantially constant volume of air.

1. A method of controlling a powered air purifying respirator blower system to deliver an airflow to a user to detect a low air-pressure high airflow event, the system comprising a fan powered by an electric motor, controlled by an electronic control unit for delivering a forced flow of filtered air to a user, and the electronic control unit having a plurality of data points representing events defining an acceptable operating range in terms of different characteristics of the blower system stored therein, the method comprising:
sampling a characteristic that represents the operating condition of the blower system to obtain a sampled data point;
comparing the sampled data point and the stored data point representing a low air pressure high airflow event, for the same characteristic;
repeating the sampling during a fixed time period, and if the comparing step indicates the low air-pressure high airflow event has been reached for the majority of the time period;
activating an alarm.

2. Method of claim 1, wherein sampling is carried out by the electronic control unit.

3. Method of claim 1, wherein the characteristic sampled is one of: voltage across the motor; current through the motor; speed of the motor; or any combination thereof.

4. Method of claim 3, wherein the low air-pressure high airflow event is a minimum acceptable value for the characteristic sampled.

5. Method of claim 1, wherein sampling is carried out using a sensor external to the electronic control unit.

6. Method of claim 1, wherein the characteristic sampled is one of air-pressure or airflow.

7. Method of claim 6, wherein if the characteristic is air-pressure, the low air-pressure high airflow event is a minimum acceptable value.

8. Method of claim 6, wherein if the characteristic is airflow, the low air-pressure high airflow event is a maximum acceptable value.

9. Method according to claim 1, wherein the alarm is at least one or more of an audible alarm, a visible alarm, or a vibration alarm.

10. Method according to claim 1, wherein the fixed time period is in the range of 3 to 30 seconds.

11. Method according to claim 1, wherein the respirator delivers a substantially uniform volumetric airflow to a user.

12. Method according to claim 1, wherein the respirator operates at one of a substantially constant current or a substantially constant voltage.

13. A respirator employing a method of claim 1, to deliver a forced flow of filtered air to a contained user environment.

14. A respirator according to claim 13 wherein the contained user environment is one of a mask, a helmet or a hood.

15. A respirator according to claim 13 wherein the contained user environment is a suit.
